(19) United States
(12) Patent Application Publication
(10) Pub. No.: US 2006/0028233 A1
(43) Pub. Date: Feb. 9, 2006

(54) Pixel testing method, method of correcting output voltage of pixel, defect pixel processing device, defect pixel processing program, defect pixel processing method, and recording medium having program

(75) Inventor: Shinichi Arazaki, Shimosuwa-machi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/195,781

(22) Filed: Aug. 3, 2005

(30) Foreign Application Priority Data
Aug. 4, 2004 (JP) 2004-227561
Jul. 6, 2005 (JP) 2005-197789

(51) Int. Cl. G01R 31/00

(52) U.S. Cl. 324/770

(57) ABSTRACT

A pixel testing method, wherein, in photoelectric transducers in which a plurality of first color pixels for converting brightness of a first color of at least two colors contained in light from an object to be photographed into a voltage and a plurality of second color pixels for converting brightness of a second color into a voltage, one of the plurality of the first color pixel is a tested pixel, and it is determined whether the tested pixel adjacent to at least two second color pixels of the plurality of the second color pixels is a defect pixel, includes: detecting a first voltage difference between two voltages output from the tested pixel and first one of the first color pixels adjacent to first one of the second color pixels which is one of the at least two second color pixels; detecting a second voltage difference between two voltages output from the first one of the second color pixels and second one of second color pixels which is the other of the at least two second color pixels; and determining whether the tested pixel is the defect pixel based on the first voltage difference and the second voltage difference.

### BACKGROUND

The present invention relates to a method of testing a plurality of pixels composing a single-chip imaging sensor of an electronic apparatus having an imaging function such as a portable telephone or a digital camera, a method of correcting an output voltage thereof, a defect pixel processing device, a defect pixel processing program, a defect pixel processing method, and a recording medium having the program.

It is determined whether a pixel is a defect pixel (a pixel of which a conversion property is not in an allowable range), based on a signal level difference between the corresponding pixel and an adjacent pixel having the same color as the corresponding pixel and a signal level difference between the corresponding pixel and a peripheral pixel having the same color as the corresponding pixel, as disclosed in Patent Document 1. Further, correction of an output signal of the defect pixel is performed by calculating a signal of an adjacent pixel and a signal of an isolation pixel, as disclosed in Patent Document 2.

Patent Document 1: JP-A-6-30425

Patent Document 2: JP-A-6-205302

However, in the former pixel testing method, since the adjacent pixel or the peripheral pixel having the same color is processed, the defect pixel can not be detected when the adjacent pixel and the peripheral pixel have different colors. Further, in the latter method of correcting the output signal of the pixel, the output signal of the defect pixel can be adequately corrected when a change interval of a region which extends on a plane is large. However, the detail of image information may be lost according to the process of the output signal of the adjacent pixel and the output signal of the peripheral pixel and thus the output signal of the defect pixel can not be adequately corrected.

Furthermore, when pixel defect is accurately detected according to pixel variation in all directions, a line memory used for detecting a defect pixel must be applied and thus costs of the device increase or the device is complicated.

### SUMMARY

The invention has been made to address the above problems. An advantage of the invention is to provide a method of testing a new pixel to easily and accurately determine whether a tested pixel is a defect pixel, a method of correcting an output voltage of a pixel, a defect pixel processing device, a defect pixel processing program, a defect pixel processing method, and a recording medium having a program.

[First Aspect]

According to a first aspect of the invention, a pixel testing method, wherein, in photoelectric transducers in which a plurality of first color pixels for converting brightness of a first color of at least two colors contained in light from an object to be photographed into a voltage and a plurality of second color pixels for converting brightness of a second color into a voltage so that adjacent color pixels are arranged not to be the same in color, one of the plurality of the first color pixel is a tested pixel, and it is determined whether the tested pixel adjacent to at least two second color pixels of the plurality of the second color pixels is a defect pixel, includes: detecting a first voltage difference between two voltages output from the tested pixel and first one of the first color pixels adjacent to first one of the second color pixels which is one of the at least two second color pixels; detecting a second voltage difference between two voltages output from the first one of the second color pixels and second one of second color pixels which is the other of the at least two second color pixels; and determining whether the tested pixel is the defect pixel based on the first voltage difference and the second voltage difference.

According to the pixel testing method according to the first aspect of the invention, it is determined whether the tested pixel is the defect pixel based on the first voltage difference between the output voltage of the tested pixel which is the first color pixel and the output voltage of the first one of the first color pixels which is the first color pixel adjacent to the tested pixel and having the same color as the tested pixel, and the second voltage difference between the output voltage of the first one of the second color pixels which is one of the second color pixels adjacent to the tested pixel and the output voltage of the second one of the second color pixels which is the other of the second color pixels adjacent to the tested pixel. Thus, although the pixel adjacent to the tested pixel is the second color pixel which is different in color from the tested pixel, it can be determined whether the tested pixel is the defect pixel.

[Second Aspect]

According to the pixel testing method of a second aspect of the invention, when a probability that the tested pixel is the defect pixel is estimated based on the first voltage difference, the determination is made based on the second voltage difference about whether the estimation is adequate not.

[Third Aspect]

According to the pixel testing method of a third aspect of the invention, detecting a third voltage difference between two voltages output from the tested pixel and third one of the first color pixels adjacent to the second one of the second color pixels is further included, and, in the determining, it is determined whether the tested pixel is the defect pixel based on the first voltage difference, the second voltage difference, and the third voltage difference.

[Fourth Aspect]

According to the pixel testing method of a fourth aspect of the invention, when a probability that the tested pixel is the defect pixel is estimated based on the first voltage difference and the third voltage difference, the determination is made bout whether the estimation is adequate based on the second voltage difference not.

[Fifth Aspect]

According to the pixel testing method of a fifth aspect of the invention, estimating light brightness distribution based on a plurality of the third voltage differences obtained by sequentially detecting the third voltage difference between the voltages output from the second color pixels which have a same color and are adjacent to each other with respect to the plurality of the second color pixels is further included, and, in the determining, it is determined whether the tested pixel is the defect pixel with reference to the light brightness distribution estimated by the estimating.

[Sixth Aspect]

According to a sixth aspect of the invention, a method of correcting an output voltage of a pixel which, in a photoelectric transducer having a plurality of pixels for converting brightness of a color contained in light from an object to be photographed into a voltage, corrects an output voltage of a pixel which is determined to a defect pixel because the voltage exceeds an allowable range related to conversion performance of a plurality of elements and has high brightness, includes applying a voltage corresponding to highest brightness of the voltages output from at least two pixels which sandwich or surround the pixel as an output voltage of the pixel which is determined to be the defect pixel.

According to a first method of correcting the output voltage of the pixel, since a voltage corresponding to highest brightness of the voltages output from at least two pixels which sandwich or surround the pixel is applied as an output voltage of the pixel which is determined to be the defect pixel because the output voltage exceeds the allowable range and has high brightness, the correction amount of the output voltage of the pixel which is determined to be the defect pixel is suppressed to a minimum and thus the affinity between the pixel and the at least two pixels which sandwich or surround the pixel can be improved. Thus, the pixel which is determined to the defect pixel is made not conspicuous.

[Seventh Aspect]

According to a seventh aspect of the invention, a method of correcting an output voltage of a pixel which, in a photoelectric transducer having a plurality of pixels for converting brightness of a color contained in light from an object to be photographed into a voltage, corrects an output voltage of a pixel which is determined to be a defect pixel because the voltage exceeds an allowable range related to conversion performance of a plurality of elements and has low brightness, includes applying a voltage corresponding to lowest brightness of the voltages output from at least two pixels which sandwich or surround the pixel as an output voltage of the pixel which is determined to the defect pixel.

According to a second method of correcting the output voltage of the pixel, the affinity between the pixel which is determined to be a defect pixel and the at least two pixels which sandwich or surround the pixel can be improved, similar to the first method of correcting the output voltage of the pixel, and thus the pixel which is determined to the defect pixel is made not conspicuous.

[Eighth Aspect]

According to an eighth aspect of the invention, a defect pixel processing device of a single-chip imaging sensor having a plurality of pixels including photoelectric transducers which receive light having different colors, includes: a tested pixel specifying unit that specifies a predetermined tested pixel of the plurality of the photoelectric transducers; a first voltage difference detecting unit that detects a voltage difference between an output voltage of the tested pixel specified by the tested pixel specifying unit and an output voltage of an adjacent pixel having the same color as the tested pixel; a second voltage difference detecting unit that detects a voltage difference between an output voltage of a reference pixel adjacent to the tested pixel and having a color different from that of the tested pixel and an output voltage of another reference pixel having the same color as the reference pixel and adjacent to the reference pixel; and a defect determining unit that determines defect of the tested pixel based on the voltage difference detected by the first voltage difference detecting unit and the voltage difference detected by the second voltage difference detecting unit.

That is, for example, the voltage difference between the output voltage of the tested pixel specified by the tested pixel specifying unit and the output voltage of the adjacent pixel having the same color as the tested pixel. If the voltage difference is larger than the predetermined threshold value, a probability that the tested pixel is the defect pixel is high. Also, the voltage difference between the output voltage of the reference pixel adjacent to the tested pixel and having the color different from that of the tested pixel and the output voltage of another reference pixel adjacent to the reference pixel and having the same color as the reference pixel is detected by the second voltage difference detecting unit. If the voltage difference is smaller than the predetermined threshold value, a probability that the tested pixel is the defect pixel is very high and thus the it can be determined that the tested pixel is the defect pixel.

Thus, it can be accurately and easily determined whether the tested pixel specified by the tested pixel specifying unit is the defect pixel for generating an abnormal output voltage.

[Ninth Aspect]

According to the defect pixel processing device of a ninth aspect of the invention, in the defect pixel processing device of the eighth aspect, the defect determining unit determines that the tested pixel is not a defect pixel when the voltage difference detected by the first voltage difference detecting unit does not exceed a predetermined threshold value and determines the defect of the tested pixel based on the voltage difference detected by the second voltage difference detecting unit when the voltage difference detected by the first voltage detecting unit exceeds the predetermined threshold value.

That is, since the brightness is rapidly changed in an edge portion of an image, it can not be accurately determined whether the tested pixel is the defect pixel only by the reference although the voltage difference detected by the first voltage difference detecting unit exceeds the predetermined threshold value. Accordingly, in consideration of the voltage difference between the pixels at the vicinity of the tested pixel detected by the second voltage difference detecting unit, it is determined whether the tested pixel is the defect pixel based on the difference.

Thus, it can be accurately and easily determined whether the tested pixel specified by the tested pixel specifying unit is the defect pixel which generates an abnormal output voltage.

[Tenth Aspect]

According to the defect pixel process device of a tenth aspect of the invention, in the defect pixel processing device of the eighth aspect, a third voltage difference detecting unit which detects a voltage difference between an output voltage of the tested pixel specified by the tested pixel specifying unit and an output voltage of another adjacent pixel having the same color as the tested pixel is further included, and the defect determining unit determines that the tested pixel is not the defect pixel when the voltage difference detected by the third voltage difference detecting unit and the voltage difference detected by the first voltage difference detecting unit does not exceed the predetermined threshold value, and determines that the tested pixel is the defect pixel when one or both of the voltage difference detected by the third voltage difference detecting unit and the voltage difference detected by the first voltage difference detecting unit exceeds the predetermined threshold value.

That is, in the eighth and ninth aspects, the second voltage difference detecting unit is formed together with the first voltage difference detecting unit, and, if the voltage difference detected by the first voltage difference detecting unit exceeds the predetermined threshold value and it is determined whether the tested pixel is the defect pixel based on the voltage difference detected by the second voltage difference detecting unit. However, in the tenth aspect, the third voltage difference detecting means is further formed and it is determined whether the tested pixel is the defect pixel in consideration of the voltage difference detected by the third voltage difference detecting unit.

Thus, it can be more accurately determined whether the tested pixel specified by the tested pixel specifying unit is the defect pixel for generating an abnormal output voltage.

[Eleventh Aspect]

According to the defect pixel processing device of an eleventh aspect of the invention, in the defect pixel processing device of the tenth aspect, the third voltage difference detecting unit detects the voltage differences between the output voltage of the tested pixel and the output voltages of at least two adjacent pixels having the same color as the tested pixel, respectively, and the defect determining unit estimates brightness distribution based on a plurality of the voltage differences detected by the third voltage difference detecting unit and determines the defect of the tested pixel based on the brightness distribution.

Thus, it can be more accurately determined whether the tested pixel specified by the tested pixel specifying unit is the defect pixel for generating an abnormal output voltage.

[Twelfth Aspect]

According to the defect pixel processing device of a twelfth aspect of the invention, in the defect pixel processing device of the eleventh aspect, when the pixels of which the output voltages are detected by the first and second voltage difference detecting units exist in the same line as the tested pixel, the third voltage difference detecting unit selects another adjacent pixel having the same color on a line separate from the corresponding line and detects the voltage difference between the output voltage of the adjacent pixel and the output voltage of the tested pixel.

Thus, the defect pixel determining process can be performed in consideration of the vertical and horizontal correlation as well as the same direction.

[Thirteenth Aspect]

According to the defect pixel processing device of a thirteenth aspect, in the defect pixel processing device of the twelfth aspect, a storing unit which stores the output voltage of each pixel in an N-line unit of all the pixels of a single-chip imaging sensor is included, and the third voltage difference detecting unit selects another adjacent pixel having the same color on a line separate from the corresponding line and detects the voltage difference between the output voltage of the adjacent pixel and the output voltage of the tested pixel, in a range of each pixel stored in the storing unit.

Thus, if the storing unit (line memory) for storing, for example, four lines of the pixel data exists, four line of the pixels can processed at a time and thus a rapid process can be realized. Also, whenever one line is finished, the defect pixel determining process similar to that of the twelfth aspect can be performed by storing next four lines, the line memory need not be newly provided and thus cost of the device or the device does not increase or the device is not complicated.

[Fourteen Aspect]

According to the defect pixel processing device of a fourteen aspect of the invention, in the defect pixel processing device of the tenth aspect, the third voltage difference detecting unit detects the voltage differences between the output voltage of the tested pixel and the output voltages of at least two adjacent pixels having the same color from the tested pixel, respectively, and the defect determining unit estimates brightness distribution based on the plurality of the voltage differences detected by the third voltage difference detecting unit and determines the defect of the tested pixel based on the brightness distribution.

Thus, it can be more accurately determined whether the tested pixel specified by the tested pixel specifying unit is the defect pixel for generating an abnormal output voltage.

[Fifteen Aspect]

According to the defect pixel processing device of a fifteen aspect of the invention, in the defect pixel processing device of any one of the eighth through fourteen aspects, an output voltage correcting unit that corrects the output voltage of the tested pixel which is determined to be the defect pixel by the defect determining unit is included, and the output voltage correcting unit corrects the output voltage of the defect pixel to the output voltage corresponding to highest brightness of the voltages output from at least two adjacent pixels which sandwich or surround the defect pixel.

Thus, it can be determined whether the tested pixel specified by the tested pixel specifying unit is the defect pixel for generating an abnormal output voltage. Also, since the output voltage correcting unit is included, when the tested pixel is the defect pixel, the output voltage thereof can be corrected to an adequate value.

[Sixteen Aspect]

According to the defect pixel processing device of a sixteen aspect of the invention, in the defect pixel processing device of any one of the eighth through fourteen aspects, an output voltage correcting unit that corrects the output voltage of the tested pixel which is determined to be the defect pixel by the defect determining unit is included, and the output voltage correcting unit corrects the output voltage of the defect pixel to the output voltage corresponding to lowest brightness of the voltages output from at least two adjacent pixels which sandwich or surround the defect pixel.

Thus, it can be determined whether the tested pixel specified by the tested pixel specifying unit is the defect pixel for generating an abnormal output voltage. Also, since the output voltage correcting unit is included, when the tested pixel is the defect pixel, the output voltage thereof can be corrected to an adequate value.

[Seventeenth Aspect]

According to a seventeenth aspect of the invention, a defect pixel processing program which detects a defect pixel of a single-chip imaging sensor having a plurality of pixels including photoelectric transducers which receives light having different colors, and allows a computer to function as a tested pixel specifying unit that specifies a predetermined tested pixel of the plurality of the photoelectric transducers; a first voltage difference detecting unit that detects a voltage difference between an output voltage of the tested pixel specified by the tested pixel specifying unit and an output voltage of an adjacent pixel having the same color as the tested pixel; a second voltage difference detecting unit that detects a voltage difference between an output voltage of a reference pixel adjacent to the tested pixel and having a color different from that of the tested pixel and an output voltage of another reference pixel having the same color as the reference pixel and adjacent to the reference pixel; and a defect determining unit that determines defect of the tested pixel based on the voltage difference detected by the first voltage difference detecting unit and the voltage difference detected by the second voltage difference detecting unit.

Thus, similar to the eighth aspect, it can be accurately and easily determined whether the tested pixel specified by the tested pixel specifying unit is the defect pixel for generating an abnormal output voltage.

Most electronic apparatuses which sell at a market, such as a digital camera or a portable telephone embedding the device of the invention include a computer system including a central processing unit (CPU), a storage (RAM, ROM), an input/output device and each means can be realized by software using the computer system and thus can be more economically and easily realized than the case that each unit-is realized using dedicated hardware. Also, a version can be easily updated by function modification and improvement obtained by rewriting a portion of the program.

[Eighteen Aspect]

According to the defect pixel processing program of a eighteen aspect of the invention, in the defect pixel processing program of the seventeenth aspect, the detect determining unit determines that the tested pixel is not the defect pixel when the voltage detected by the first voltage difference detecting unit does not exceed the predetermined threshold value, and determines whether the tested pixel is the defect pixel based on the voltage difference detected by the second voltage difference detecting unit when the voltage detected by the first voltage difference detecting unit exceeds the predetermined threshold value.

Thus, it can be accurately and easily determined whether the tested pixel specified by the tested pixel specifying unit is the defect pixel which generates an abnormal output voltage.

Furthermore, similar to the seventeenth aspect, each unit can be realized by software using the computer system included in the electronic apparatus such as the digital camera or the portable telephone and thus can be more economically and easily realized than the case that each unit is realized using dedicated hardware. Also, a version can be easily updated by function modification and improvement obtained by rewriting a portion of the program.

[Nineteen Aspect]

According to the defect pixel processing program of a nineteen aspect of the invention, in the defect pixel processing program of the seventeenth aspect, a third voltage difference detecting unit which detects a voltage difference between an output voltage of the tested pixel specified by the tested pixel specifying unit and an output voltage of another adjacent pixel having the same color as the tested pixel is included, and the defect determining unit determines that the tested pixel is not the defect pixel when the voltage difference detected by the third voltage difference detecting unit and the voltage difference detected by the first voltage difference detecting unit does not exceed the predetermined threshold value, and determines that the tested pixel is the defect pixel when one or both of the voltage difference detected by the third voltage difference detecting unit and the voltage difference detected by the first voltage difference detecting unit exceeds the predetermined threshold value.

Thus, similar to the tenth aspect, it can be more accurately determined whether the tested pixel specified by the tested pixel specifying unit is the defect pixel for generating an abnormal output voltage.

Furthermore, similar to the seventeenth aspect, each unit can be realized by software using the computer system included in the electronic apparatus such as the digital camera or the portable telephone and thus can be more economically and easily realized than the case that each unit is realized using dedicated hardware. Also, a version can be easily updated by function modification and improvement obtained by rewriting a portion of the program.

[Twentieth Aspect]

According to the defect pixel processing program of a twentieth aspect of the invention, in the defect pixel processing program of the nineteenth aspect, the third voltage difference detecting unit detects the voltage differences between the output voltage of the tested pixel and the output voltages of at least two adjacent pixels having the same color as the tested pixel, respectively, and the defect determining unit estimates brightness distribution based on a plurality of the voltage differences detected by the third voltage difference detecting unit and determines the defect of the tested pixel based on the brightness distribution.

Thus, similar to the eleventh aspect, it can be more accurately determined whether the tested pixel specified by the tested pixel specifying unit is the defect pixel for generating an abnormal output voltage.

Furthermore, similar to the seventeenth aspect, each unit can be realized by software using the computer system included in the electronic apparatus such as the digital camera or the portable telephone and thus can be more economically and easily realized than the case that each unit is realized using dedicated hardware. Also, a version can be easily updated by function modification and improvement obtained by rewriting a portion of the program.

[Twenty First Aspect]

According to the defect pixel processing program of a twenty first aspect of the invention, in the defect pixel processing program of the twentieth aspect, when the pixels of which the output voltages are detected by the first and second voltage difference detecting units exist in the same line as the tested pixel, the third voltage difference detecting unit selects another adjacent pixel having the same color on a line separate from the corresponding line and detects the voltage difference between the output voltage of the adjacent pixel and the output voltage of the tested pixel.

Thus, similar to the twelfth aspect, it can be more accurately determined whether the tested pixel specified by the tested pixel specifying unit is the defect pixel for generating an abnormal output voltage.

Furthermore, similar to the seventeenth aspect, each unit can be realized by software using the computer system included in the electronic apparatus such as the digital camera or the portable telephone and thus can be more economically and easily realized than the case that each unit is realized using dedicated hardware. Also, a version can be easily updated by function modification and improvement obtained by rewriting a portion of the program.

[Twenty Second Aspect]

According to the defect pixel processing program of a twenty second aspect of the invention, in the defect pixel processing program of the twenty first aspect, a storing unit which stores the output voltage of each pixel in an N-line unit of all the pixels of a single-chip imaging sensor is included, and the third voltage difference detecting unit selects another adjacent pixel having the same color on a line separate from the corresponding line and detects the voltage difference between the output voltage of the adjacent pixel and the output voltage of the tested pixel, in a range of each pixel stored in the storing unit.

Thus, similar to the thirteen aspect, four line of the pixels can processed at a time and thus a rapid process can be realized. Also, the line memory need not be newly provided and thus cost of the device or the device does not increase or the device is not complicated.

Furthermore, similar to the seventeenth aspect, each unit can be realized by software using the computer system included in the electronic apparatus such as the digital camera or the portable telephone and thus can be more economically and easily realized than the case that each unit is realized using dedicated hardware. Also, a version can be easily updated by function modification and improvement obtained by rewriting a portion of the program.

[Twenty Third Aspect]

According to the defect pixel processing program of a twenty third aspect of the invention, in the defect pixel processing program of the twentieth aspect, the third voltage difference detecting unit detects the voltage differences between the output voltage of the tested pixel and the output voltages of at least two adjacent pixels having the same color with the tested pixel, respectively, and the defect determining unit estimates brightness distribution based on the plurality of the voltage differences detected by the third voltage difference detecting unit and determines the defect of the tested pixel based on the brightness distribution.

Thus, similar to the fourteen aspect, it can be more accurately determined whether the tested pixel specified by the tested pixel specifying unit is the defect pixel which generates an abnormal output voltage.

Furthermore, similar to the seventeenth aspect, each unit can be realized by software using the computer system included in the electronic apparatus such as the digital camera or the portable telephone and thus can be more economically and easily realized than the case that each unit is realized using dedicated hardware. Also, a version can be easily updated by function modification and improvement obtained by rewriting a portion of the program.

[Twenty Fourth Aspect]

According to the defect pixel processing program of a twenty fourth aspect of the invention, in the defect pixel processing program any one of the seventeenth through twenty third aspects, an output voltage correcting unit that corrects the output voltage of the tested pixel which is determined to the defect pixel by the defect determining unit is included, and the output voltage correcting unit corrects the output voltage of the defect pixel to the output voltage corresponding to highest brightness of the voltages output from at least two adjacent pixels which sandwich or surround the defect pixel.

Thus, similar to the fifteen aspect, it can be more accurately determined whether the tested pixel specified by the tested pixel specifying unit is the defect pixel for generating an abnormal output voltage. Also, since the output voltage correcting unit is included, when the tested pixel is determined to be the defect pixel, the output voltage thereof can be corrected to an adequate value.

Furthermore, similar to the seventeenth aspect, each unit can be realized by software using the computer system included in the electronic apparatus such as the digital camera or the portable telephone and thus can be more economically and easily realized than the case that each unit is realized using dedicated hardware. Also, a version can be easily updated by function modification and improvement obtained by rewriting a portion of the program.

[Twenty Fifth Aspect]

According to the defect pixel processing program of a twenty fifth aspect of the invention, in the defect pixel processing program any one of the seventeenth through twenty third aspects, an output voltage correcting unit that corrects the output voltage of the tested pixel which is determined to the defect pixel by the defect determining unit is included, and the output voltage correcting unit corrects the output voltage of the defect pixel to the output voltage corresponding to lowest brightness of the voltages output from at least two adjacent pixels which sandwich or surround the defect pixel.

Thus, similar to the sixteenth aspect, it can be more accurately determined whether the tested pixel specified by the tested pixel specifying unit is the defect pixel for generating an abnormal output voltage. Also, since the output voltage correcting unit is included, when the tested pixel is the defect pixel, the output voltage thereof can be corrected to an adequate value.

Furthermore, similar to the seventeenth aspect, each unit can be realized by software using the computer system included in the electronic apparatus such as the digital camera or the portable telephone and thus can be more economically and easily realized than the case that each unit is realized using dedicated hardware. Also, a version can be easily updated by function modification and improvement obtained by rewriting a portion of the program.

[Twenty Sixth Aspect]

According to the defect pixel processing program of a twenty sixth aspect of the invention, there is provided a computer-readable recoding medium having embodied thereon the defect pixel processing program any one of the seventeenth through twenty fifth aspects.

Thus, the defect pixel processing program of any one of the seventeenth through twenty fifth aspects can be easily and surely provided to a use through a computer-readable recording medium such as a CD-ROM, a DVE-ROM, a FD, a semiconductor chip.

[Twenty Seventh Aspect]

According to a twenty seventh aspect of the invention, a method of detecting a defect pixel of a single-chip imaging sensor having a plurality of pixels including photoelectric transducers which receive light having different colors, includes: specifying a predetermined tested pixel of the plurality of the photoelectric transducers; detecting a voltage difference between an output voltage of the tested pixel specified by the tested pixel specifying unit and an output voltage of an adjacent pixel having the same color as the tested pixel; detecting a voltage difference between an output voltage of a reference pixel adjacent to the tested pixel having a color different from that of the tested pixel and an output voltage of another reference pixel having the same color as the reference pixel and adjacent to the reference pixel; and determining the defect of the tested pixel based on the voltage difference detected by the first voltage difference detecting unit and the voltage difference detected by the second voltage difference detecting unit.

Thus, similar to the eighth aspect, it can be accurately and easily determined whether the tested pixel specified by the tested pixel specifying unit is the defect pixel for generating an abnormal output voltage.

[Twenty Eighth Aspect]

According to the defect pixel processing method of a twenty eighth aspect of the invention, in the defect pixel processing method of the twenty seventh aspect, the detect determining step determines that the tested pixel is not the defect pixel when the voltage detected by the first voltage difference detecting unit does not exceed the predetermined threshold value, and determines whether the tested pixel is the defect pixel based on the voltage difference detected by the second voltage difference detecting unit when the voltage detected by the first voltage difference detecting unit exceeds the predetermined threshold value.

Thus, similar to the ninth aspect, it can be accurately and easily determined whether the tested pixel specified by the tested pixel specifying unit is the defect pixel for generating an abnormal output voltage.

[Twenty Ninth Aspect]

According to the defect pixel processing method of a twenty ninth aspect of the invention, in the defect pixel processing method of the twenty seventh aspect, a third voltage difference detecting step which detects a voltage difference between an output voltage of the tested pixel specified by the tested pixel specifying unit and an output voltage of another adjacent pixel having the same color as the tested pixel is included, and the defect determining step determines that the tested pixel is not the defect pixel when the voltage difference detected by the third voltage difference detecting unit and the voltage difference detected by the first voltage difference detecting unit does not exceed the predetermined threshold value, and determines that the tested pixel is the defect pixel when any one or both of the voltage difference detected by the third voltage difference detecting unit and the voltage difference detected by the first voltage difference detecting unit exceeds the predetermined threshold value.

Thus, similar to the tenth aspect, it can be more accurately determined whether the tested pixel specified by the tested pixel specifying unit is the defect pixel for generating an abnormal output voltage.

[Thirtieth Aspect]

According to the defect pixel processing method of a thirtieth aspect of the invention, in the defect pixel processing method of the twenty seventh aspect, the third voltage difference detecting step detects the voltage differences between the output voltage of the tested pixel and the output voltages of at least two adjacent pixels having the same color as the tested pixel, respectively, and the defect determining step estimates brightness distribution based on a plurality of the voltage differences detected by the third voltage difference detecting unit and determines the defect of the tested pixel based on the brightness distribution.

Thus, similar to the eleventh aspect, it can be more accurately determined whether the tested pixel specified by the tested pixel specifying unit is the defect pixel for generating an abnormal output voltage.

[Thirty First Aspect]

According to the defect pixel processing method of a thirty first aspect of the invention, in the defect pixel processing method of the thirtieth aspect, when the pixels of which the output voltages are detected by the first and second voltage difference detecting units exist in the same line as the tested pixel, the third voltage difference detecting step detects the voltage difference between the output voltage of the adjacent pixel and the output voltage of the tested pixel.

Thus, similar to the twelfth aspect, it can be more accurately determined whether the tested pixel specified by the tested pixel specifying unit is the defect pixel for generating an abnormal output voltage.

[Thirty Second Aspect]

According to the defect pixel processing method of a thirty second aspect of the invention, in the defect pixel processing method of the thirty first aspect, a storing step which stores the output voltage of each pixel in an N-line unit of all the pixels of a single-chip imaging sensor is included, and the third voltage difference detecting step selects another adjacent pixel having the same color on a line separate from the corresponding line and detects the voltage difference between the output voltage of the adjacent pixel and the output voltage of the tested pixel, in a range of each pixel stored in the storing unit.

Thus, similar to the thirteen aspect, four line of the pixels can processed at a time and thus a rapid process can be realized. Also, the line memory need not be newly provided and thus cost of the device or the device does not increase or the device is not complicated.

[Thirty Third Aspect]

According to the defect pixel processing method of a thirty third aspect of the invention, in the defect pixel processing method of the twentieth aspect, the third voltage difference detecting step detects the voltage differences between the output voltage of the tested pixel and the output voltages of at least two adjacent pixels having the same color from the tested pixel, respectively, and the defect determining step estimates brightness distribution based on the plurality of the voltage differences detected by the third voltage difference detecting unit and determines the defect of the tested pixel based on the brightness distribution.

Thus, similar to the fourteen aspect, it can be more accurately determined whether the tested pixel specified by the tested pixel specifying unit is the defect pixel for generating an abnormal output voltage.

[Thirty Fourth Aspect]

According to the defect pixel processing program of a thirty fourth aspect of the invention, in the defect pixel processing method any one of the twenty eighth through thirty third aspects, an output voltage correcting step that corrects the output voltage of the tested pixel which is determined to the defect pixel by the defect determining unit is included, and the output voltage correcting step corrects the output voltage of the defect pixel to the output voltage corresponding to highest brightness of the voltages output from at least two adjacent pixels which sandwich or surround the defect pixel.

Thus, similar to the fifteen aspect, it can be more accurately determined whether the tested pixel specified by the tested pixel specifying unit is the defect pixel for generating an abnormal output voltage. Also, since the output voltage correcting unit is included, when the tested pixel is the defect pixel, the output voltage thereof can be corrected to an adequate value.

[Thirty Fifth Aspect]

According to the defect pixel processing method of a thirty fifth aspect of the invention, in the defect pixel processing method any one of the twenty eighth through thirty third aspects, an output voltage correcting step that corrects the output voltage of the tested pixel which is determined to the defect pixel by the defect determining unit is included, and the output voltage correcting step corrects the output voltage of the defect pixel to the output voltage corresponding to lowest brightness of the voltages output from at least two adjacent pixels which sandwich or surround the defect pixel.

Thus, similar to the sixteenth aspect, it can be more accurately determined whether the tested pixel specified by the tested pixel specifying unit is the defect pixel for generating an abnormal output voltage. Also, since the output voltage correcting unit is included, when the tested pixel is the defect pixel, the output voltage thereof can be corrected to an adequate value.

### BRIEF DESCRIPTION OF THE DRAWINGS

The invention will be described with reference to the accompanying drawings, wherein like numbers reference like elements, and wherein:

FIG. 1 is a block diagram of a defect pixel processing device according to a first embodiment of the invention;

FIG. 2 illustrates a construction of hardware for realizing the device of the invention by software;

FIG. 3 illustrates a photoelectric transducer of the first embodiment;

FIG. 4 illustrates light incident to a pixel of the first embodiment;

FIG. 5 illustrates a pixel testing method of the first embodiment;

FIG. 6 illustrates a pixel used in the pixel testing method of a first modification example;

FIG. 7 illustrates a pixel used in the pixel testing method of the first modification example;

FIG. 8 illustrates a pixel used in the pixel testing method of the first modification example;

FIG. 9 illustrates a pixel used in the pixel testing method of a second modification example;

FIG. 10 illustrates a pixel used in the pixel testing method of a third modification example;

FIG. 11 illustrates a pixel used in the pixel testing method of the third modification example;

FIG. 12 is a flowchart of processing the pixel testing method of the third modification example using four line memories;

FIG. 13 illustrates a location relationship between a tested pixel and a peripheral pixel thereof;

FIG. 14 illustrates a line moving direction and a process direction;

FIGS. 15(A) to (D) illustrate concrete examples of steps S21 through S23 of FIG. 12;

FIGS. 16(A) to (D) illustrates a concrete example of steps S21 through S24 of FIG. 12;

FIGS. 17(A) and (B) illustrate another concrete examples of steps S21 through S24 of FIG. 12;

FIG. 18 illustrates a pixel used in the pixel testing method of the third modification example;

FIG. 19 illustrates a pixel used in the pixel testing method of a fourth modification example;

FIG. 20 illustrates a photoelectric transducer of a second embodiment; and

FIG. 21 illustrates an example of a computer-readable recording medium having a defect pixel processing program according to the invention.

### DETAILED DESCRIPTION OF EMBODIMENTS

Hereinafter, embodiments according to the invention will be described with reference to the accompanying drawings.

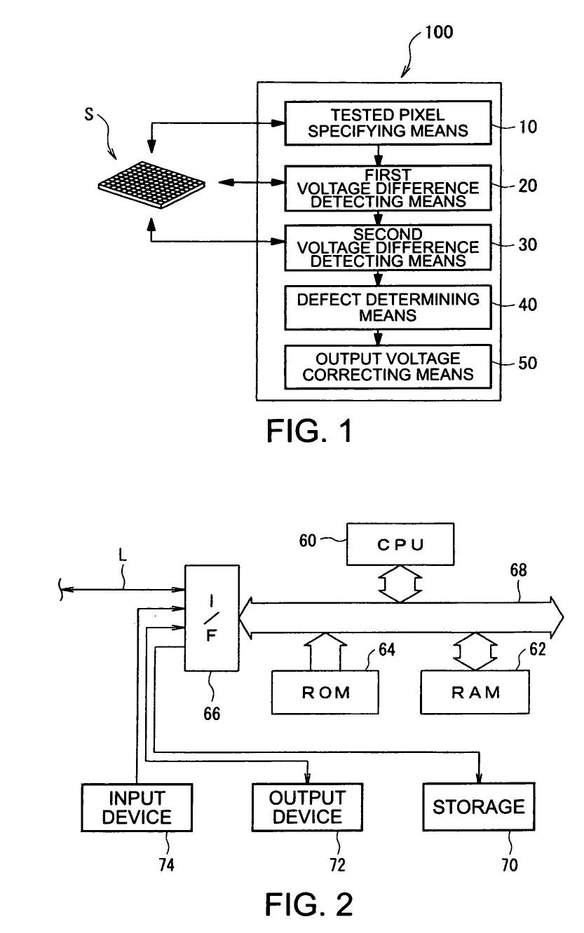

FIGS. 1 through 22 illustrate a pixel testing method, a method of correcting an output voltage of a pixel, a defect pixel processing device, a defect pixel processing program, a defect pixel processing method, and a recording medium having a program according to the embodiments of the invention.

FIG. 1 is a block diagram of a defect pixel processing device 100 according to a first embodiment of the invention.

As shown, the defect pixel processing device 100 includes a tested pixel specifying means 10 for specifying a tested pixel of a plurality of pixels composing a single-chip imaging sensor S, a first voltage difference detecting means 20 for detecting a voltage difference between an output voltage of the tested pixel specified by the tested pixel specifying means 10 and an output voltage of an adjacent pixel having the same color as the tested pixel, a second voltage difference detecting means 30 for detecting a voltage difference between an output voltage of a reference pixel which is adjacent to the tested pixel and has a color different from that of the tested pixel and an output voltage of another reference pixel which is adjacent to the above-referenced reference pixel and has the same color as the above-referenced reference pixel, a defect determining means 40 for determining defect of the tested pixel based on the voltage difference detected by the first voltage difference detecting means 10 and the voltage difference detected by the second voltage difference detecting means 20, and an output voltage correcting means 50 for correcting the output voltage of the tested pixel which is determined to the defect pixel by the defect determining means 40.

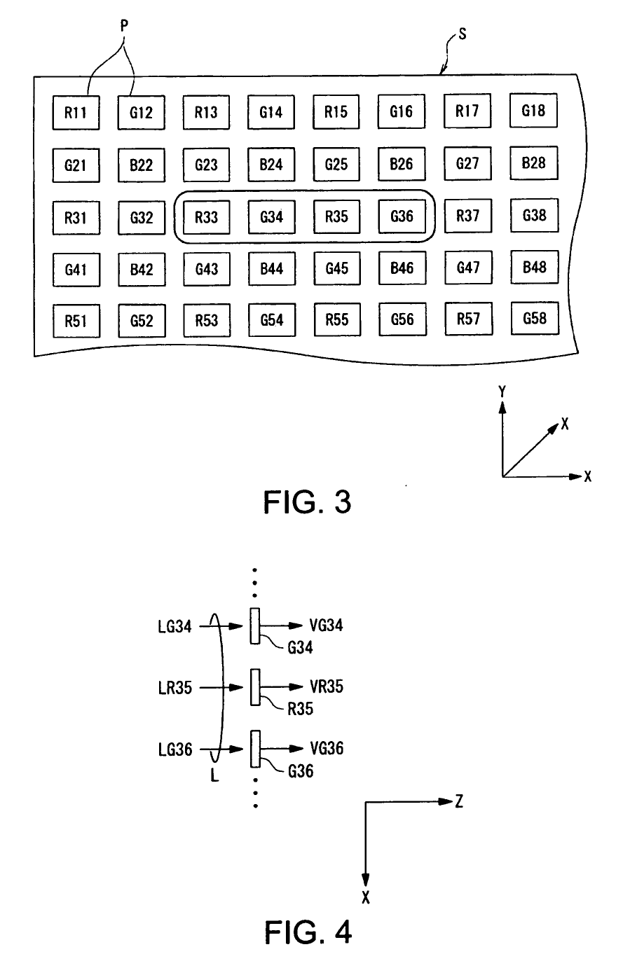

First, the tested pixel specifying means 10 specifies all the pixels of a scan direction when the pixels which are arranged on a light receiving surface of the single-chip imaging sensor S in all direction are sequentially scanned. For example, as shown in FIG. 3, in the case of the single-chip imaging sensor S in which pixels P includes photoelectric transducers having different colors in all directions, a scan process is horizontally performed from a left and upper pixel R11, the line moves downwardly by one line when a right end pixel of the line is reached, and the scan process is performed from a left end pixel G21 of the line in a right direction. Thus, the tested pixel is sequentially specified.

Next, the first voltage difference detecting means 20 provides a function of detecting the voltage difference between the output voltage of the tested pixel P and the output voltage of the adjacent pixel having the same color as the tested pixel P.

For example, as shown in FIG. 3, if the tested pixel P is a red color pixel “R35” which is located at a third row and a fifth column and the adjacent pixel having the same color as the tested pixel is a red color pixel “R33” which is located at the third row and a third column, the voltage difference between the output voltage of the pixel “R35” and the output voltage of the pixel “R33” are detected and input to the second voltage difference detecting means 30.

The second voltage difference detecting means 30 provides a function of detecting the voltage difference between the output voltage of a reference pixel which is adjacent to the tested pixel P and has a color different from that of the tested pixel and the output voltage of another reference pixel which is adjacent to the above-referenced reference pixel and has the same color as the above-referenced reference pixel.

For example, as shown in FIG. 3, if the reference pixel P which is adjacent to the tested pixel P of the red color pixel “R35” and has a difference color is a green color pixel “G34” and the adjacent reference pixel having the same color as the pixel “G34” is a green color pixel “G36” which is located at the third row and a sixth column, the voltage difference between the output voltage of the pixel “G34” and the output voltage of the pixel “G36” are detected and input to the defect determining means 40.

Next, the defect determining means 40 provides a function of determining defect of the tested pixel P based on the voltage difference detected by the first voltage difference detecting means 10 and the voltage difference detected by the second voltage difference detecting means 20. A concrete example thereof will be described later.

The output voltage correcting means 50 provides a function of correcting the output voltage of the tested pixel which is determined to the defect pixel by the defect determining means 40. A concrete example thereof will be described later.

Here, the defect pixel processing device 100 includes a computer system for realizing the tested pixel specifying means 10, the first voltage difference detecting means 20, the second voltage difference detecting means 30, the defect determining means 40, and the output voltage correcting means 50 on software. In a hardware construction, as shown in FIG. 2, a central processing unit (CPU) 60 for performing various controlling and operating processes, a random access memory (RAM) 62 composing a main storage, and a read only memory (ROM) 64 are connected to one another by various internal and external buses 68 including a peripheral component interconnect (PCI) bus or a industrial standard architecture (ISA) bus. The bus 68 is connected with a network L for communicating with secondary storage 70 such as a hard disk drive (HDD), an output device 72 such as a printing means, a CRT, a LCD, or monitor, an input device 74 such as an operation panel, a mouse, a keyboard, or scanner, and a print instructing device (not shown) through an input/output interface (I/F) 66.

When a voltage is applied, a system program such as BIOS stored in the ROM 64 loads various dedicated computer programs previously stored in the ROM 64 or various dedicated computer programs installed in the secondary storage 70 through a storage such as a CD-ROM, a DVD-ROM, or a flexible disk (FD) or the communication network L such as Internet to the RAM 62, and the CPU 60 executes various resources according to an instruction described in the program loaded to the RAM 62 to perform predetermined controlling and operating processes, thereby realizing the function of each means on the software.

Next, the embodiment of the process of processing the defect pixel using the defect pixel processing device 100 having the above-referenced construction will be described with reference to FIGS. 3, 4, and 5.

### First Embodiment

FIG. 3 illustrates an example of a single-chip imaging sensor S which is tested using the pixel testing method according to the first embodiment.

The single-chip imaging sensor S according to the first embodiment is, for example, formed on an electronic apparatus (not shown) having a digital imaging function such as a portable telephone or a digital camera, and includes a plurality of pixels P (“R11”, “G12”, “R13”, . . . ) which include photoelectric transducers arranged on a XY plane in a matrix, as shown in FIG. 3. Each pixel P is not adjacent to a pixel having the same color as the corresponding pixel, that is, is inserted between or surrounded by pixels P having different colors.

For example, a red color pixel “R35” which is located at a third row and a fifth column is inserted between or surrounded by a blue color pixel “B24”, a green color pixel “G25”, a blue color pixel “B26”, a green color pixel “G34”, a green color pixel “G36”, a blue color pixel B44, a green color pixel “G45”, and a blue color pixel “B46”. That is, “35” of “R35” means a pixel which is located at the third row and the fifth column, and “R”, “G”, and “B” means a pixel for converting brightness such as red, green, or blue contained in light received from an object to be photographed into a voltage.

Furthermore, in the pixels having the same color, if the colors to be converted have the same brightness, a same voltage is output.

For example, when red light “LR33”, “LR35”, and “LR37” which are contained in the light L and incident to pixels “R33”, “R35”, and “R37” have the same brightness, the voltages “VR33”, “VR35”, and “V37” output from the pixels “R33”, “R35”, and “R37” have a same size. The same is true in the green and blue pixels.

In the below description, it is assumed that a relationship that red light “LR11 (not shown)” is incident to a pixel “11R” and the pixel “R11” outputs a voltage “VR11 (not shown)” corresponding to the red light “LR11” is applied to all the pixels. Also, it is assumed that a pixel of which the voltage output from the pixel exceeds an allowable range of the pixel and has high brightness (white) is a defect pixel. Furthermore, for convenience of explanation, in the below description, it is assumed that the red color pixel “R35” is a pixel which will be tested whether it is the defect pixel (hereinafter, referred to as “tested pixel P”).

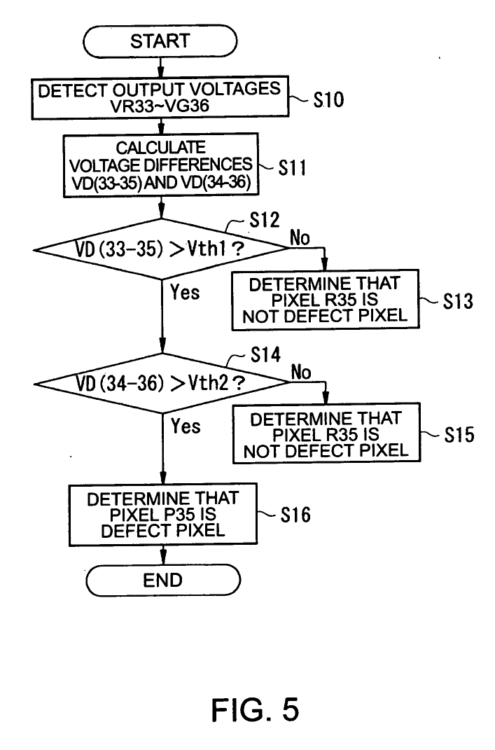

FIG. 5 illustrates a pixel testing method according to the first embodiment. Hereinafter, the pixel testing method according to the first embodiment will be described with reference to FIG. 5.

Step S10: First, in a step S10, if a tested pixel which is sequentially specified by the tested pixel specifying means 10 of the device 100 is, for example, the red color pixel “R35” which is located at the third row and the fifth column as shown in FIG. 3, the first voltage difference detecting means 20 of the device 100 detects a voltage “VR35” output from the red color pixel “R35” which receives red light “LR35”. Similarly, the second voltage difference detecting means 30 of the device 100 detects a voltage “VG34” output from a green color pixel “G34” which is a reference pixel adjacent to the red color pixel “R35” and receives green light “LG34”. Also, the first voltage difference detecting means 20 detects a voltage “VR33” output from the red color pixel “R33” which is adjacent to the green color pixel “G34” and located at the third row and the third column, that is, which is adjacent (hereinafter, referred to as “next-adjacent”) to the red color pixel “R35”, and the second voltage difference detecting means 30 detects a voltage “VG36” output from a green color pixel “G36” which is next-adjacent to the red color pixel “R35”. That is, the first voltage difference detecting means 20 detects the voltages of the red color pixels “R33” and “R35” and the second voltage difference detecting means 30 detects the voltages of the green color pixels “G34” and “G36”.

Step S11: in a step S11, the first voltage difference detecting means 20 and the second voltage difference detecting means 30 calculate the voltage difference between the output voltages of the next-adjacent pixels. More concretely, in the red color, a voltage difference “VD(33-35)” between the voltage “VR33” and the voltage “VR35” is calculated, and in the green color, a voltage difference “VD(34-36)” between the voltage “VG34” and the voltage “VG36” is calculated.

Step S12: Next, in a step S12, the defect determining means 40 of the device 100 determines whether the voltage difference “VD(33-35)” between the red color pixels is larger than a predetermined threshold voltage “Vth1 (a value which is obtained by an experience such as experiment or trial manufacture)”. If the voltage difference is not larger than the predetermined threshold voltage “Vth1”, the process is progressed to a step S13, and, if the voltage difference is larger than the predetermined threshold voltage “Vth1”, the process is progressed to a step S14.

Step S13: It is determined that the pixel “R35” is not the defect pixel.

Step S14: It is determined whether the voltage difference “VD(34-36)” is smaller than a predetermined threshold voltage “Vth2 (a value which is obtained by an experience, similar to the threshold voltage Vth1)”. If the voltage difference is not smaller than the predetermined threshold voltage “Vth2”, the process is progressed to a step S15, and, if the voltage difference is smaller than the predetermined threshold voltage “Vth2”, the process is progressed to a step S16.

Step S15: It is determined that the pixel “R35” is not the defect pixel.

Step S16: It is determined that the pixel “R35” is the defect pixel.

As mentioned above, in the pixel testing method according to the first embodiment, when the voltage difference “VD(33-35)” between the output voltage “VR35” of the red color pixel “R35” which is the tested pixel and the output voltage “VR33” of the output voltage “VR33” of the next-adjacent red color pixel “R33” is larger than the predetermined threshold voltage “Vth1”, that is, when it is estimated that there is a probability that the red color pixel “R35” is the defect pixel by the comparison with the next-adjacent pixel “R33”, and, when the voltage difference “VD(34-36)” between the output voltage “VG34” of the green color pixel “G34” and the output voltage “VG36” of the green color pixel “G36” which are adjacent to each other through the tested pixel “R35” is smaller than the predetermined threshold voltage “Vth2”, that is, when the brightness is hardly changed at the vicinity of the green color pixel “G34” and the green color pixel “G36”, the pixel “R35” is determined to the defect pixel. Accordingly, although the colors of the green color pixel “G34” and the green color pixel “G36” adjacent to the red color pixel “R35” which is the tested pixel are different from that of the tested pixel “R35”, it can be determined whether the tested pixel “R35” is the defect pixel.

### FIRST MODIFICATION EXAMPLE

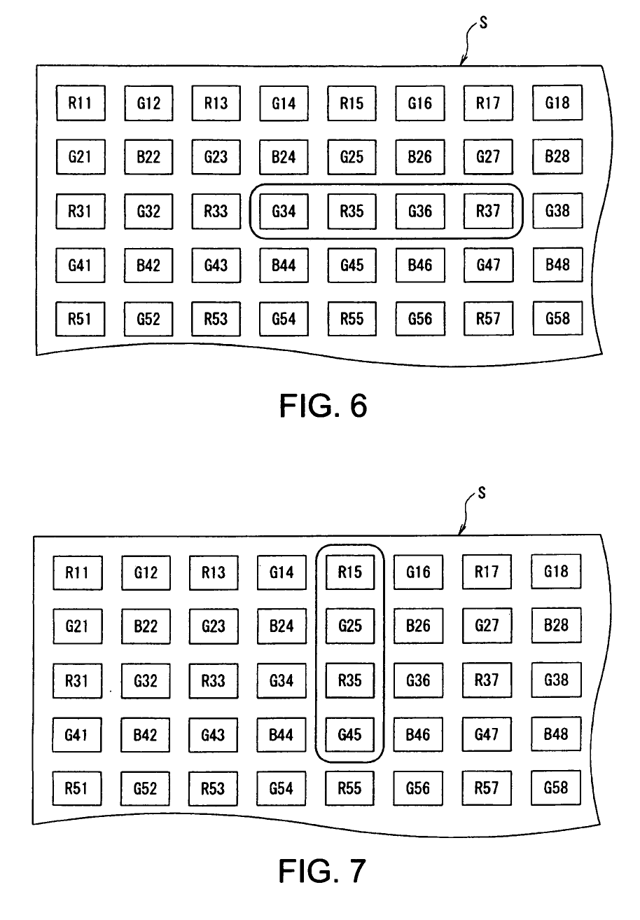

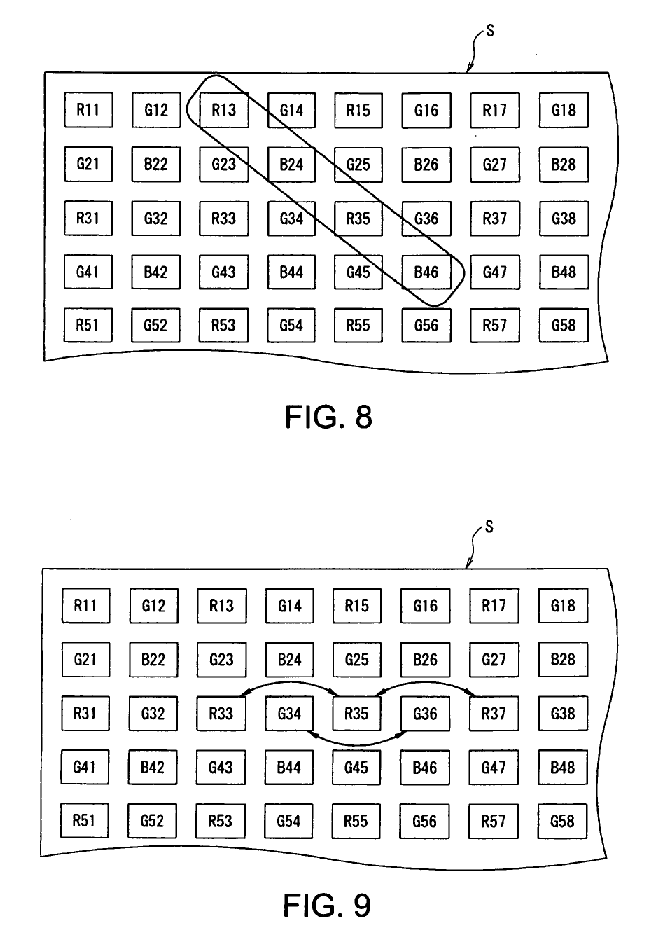

As mentioned above, instead of using the pixels “R33”, “G34”, “R35”, and “G36” which are arranged in a horizontal direction (X direction), it may be determined whether the tested pixel “R35” is the defect pixel using the pixels “G34”, “R35”, “G36”, and “R37” which are arranged in a horizontal direction (X direction) as shown in FIG. 6, using pixels “R15”, “G25, “R35”, and “G45” which are arranged in a vertical direction (Y direction) as shown in FIG. 7, or using pixels “R13”, “B24”, “R35”, and “B46” which are arranged in a diagonal direction as shown in FIG. 8.

### SECOND MODIFICATION EXAMPLE

As mentioned above, in addition to that it is determined whether the tested pixel “R35” is the defect pixel based on the result of whether the voltage difference “VD(33-35)” between the red color pixels is larger than the predetermined threshold voltage “Vth1” and whether the voltage difference “VD(34-36)” between the green color pixels is smaller than the predetermined threshold voltage “Vth2”, as shown in FIG. 9, a probability that the tested pixel “R35” is the defect pixel is estimated by the result of whether a voltage difference “VD(35-37)” between the output voltage “VR35” of the tested pixel “R35” and the output voltage “VR37” of the next-adjacent pixel “R37” is larger than the predetermined threshold voltage Vth1, that is, by two equations of voltage difference of the red color pixels “VD(33-35)”>threshold voltage “Vth1” and voltage difference of the red color pixels “VD(35-37)”>threshold voltage “Vth1” and the estimation is check based on the voltage difference of the green color pixels “VD(34-36)”<threshold voltage “Vth2”, thereby improving the accuracy of the determination whether the tested pixel “R35” is the defect pixel. In this process, for example, when both of the voltage difference “VD(33-35)”>“Vth1” and the voltage difference “VD(35-37)”>“Vth1” are satisfied, the tested pixel “R35” has brightness different from that of the peripheral pixels. In this case, the red color pixel is determined to the defect pixel.

### THIRD MODIFICATION EXAMPLE

In addition to that it is determined whether the tested pixel “R35” is the defect pixel using pixels “R33” to “G36” arranged in the horizontal direction (X direction), it can be accurately determined whether the tested pixel “R35” is the defect pixel, for example, using the pixels “R15”, “G25”, “R35”, and “G45” arranged in a vertical direction (Y direction) as shown in FIG. 10. For example, when the brightness of the red light “LR15” incident to the pixel “R15” is equal to the brightness of the red light “LR35” incident to the pixel “R35” based on the pixel “R15”˜“G45” although the tested pixel “R35” is expected to the defect pixel based on the pixels “R33” to “G36”, that is, the pixel “R35” is compared with the next-adjacent pixel “R15” to be expected to a normal pixel, the tested pixel “R35” is determined to the defect pixel.

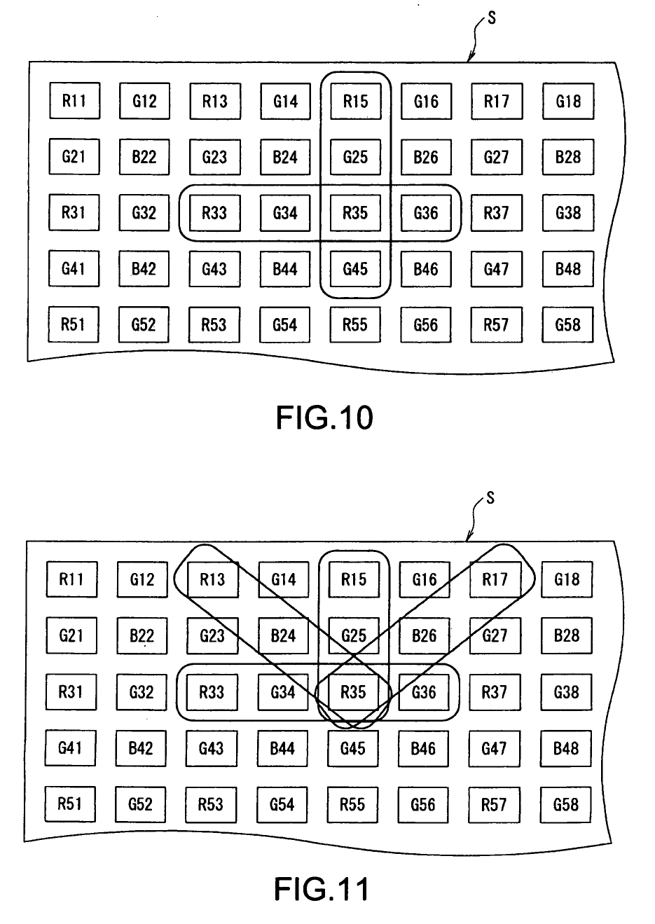

Similarly, as shown in FIG. 11, the voltage difference between the output voltages of the tested pixel “R35” and, for example, at least one of the next-adjacent pixels “R13”, “R15”, and “R17” in a line of the vertical direction (Y direction) and a line of the diagonal direction, for example, the voltage difference “VD(13-35)” between the output voltage “VR35” of the tested pixel “R35” and the output voltage “VR13” of the next-adjacent pixel “R13” is considered to obtain the same effect as the third modification example shown in FIG. 10 and reduce the size of a memory region which stores the pixel from 4 row to 3 row, compared with the third modification example.

Here, in the testing method shown in FIG. 11, if at least four rows of the line memories exist, the four rows of the pixels can be tested by one read operation.

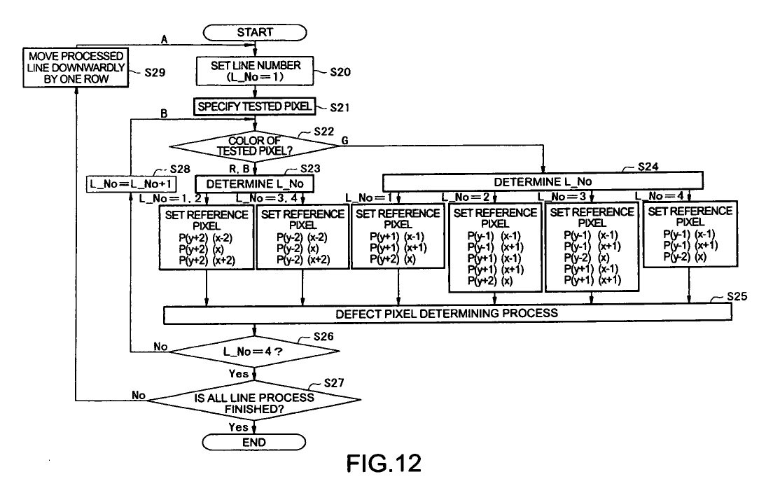

FIG. 12 is a flowchart of performing the testing method shown in FIG. 11 using the four rows of the line memories. Here, the pixel which exists in the same line as the tested pixel is omitted and the reference pixel data which exists in a separate line will be described.

Steps S20 and S21: First, an initial line number (LNo=1) of four lines in which the tested pixel exists is set in a step S20 and then the tested pixel is specified in a step S21.

Step S22: In a step S22, the color of the tested pixel specified in the step S21 is detected. When the detected color is “R” or “B”, the process is progressed to a step S23, and, when the detected color is “G”, the process is progressed to a step S24.

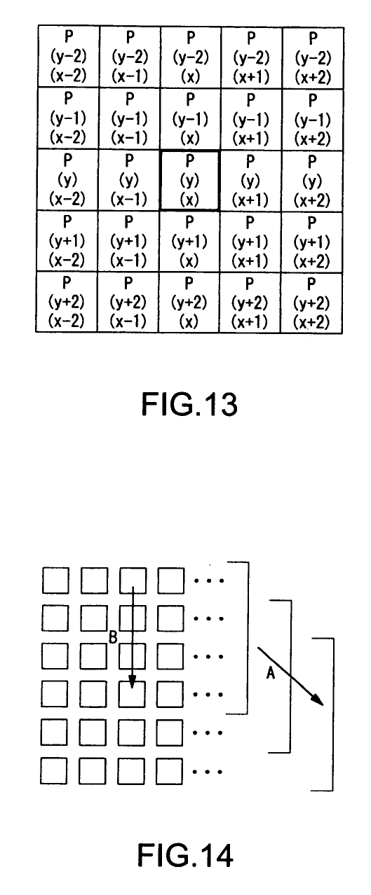

Step S23: In the step S23, the line number of the tested pixel of “R” or “B” is determined to specify three pixels which have the same color and are referred according to the line number. For example, when the line number of the tested pixel is “LNo=1” or “LNo=2”, that is, a first row or a second row, in the location (y, x) of the tested pixel P shown by a bold frame of FIG. 13, three pixels P of (y+2, x−2), (y+2, x), and (y+2, x+2) are specified as the adjacent reference pixel and these reference pixels are set to the first voltage difference detecting means 20, the second voltage difference detecting means 30, the third voltage difference detecting means (not shown), and the defect pixel determining means 40.

Furthermore, when the line number of the tested pixel is “LNo=3” or “LNo=4”, that is, a third row or a fourth row, in the location (y, x) of the tested pixel P shown by a bold frame of FIG. 13, three pixels P of (y−2, x−2), (y−2, x), and (y−2, x+2) are specified as the adjacent reference pixel and these reference pixels are similarly set to the first voltage difference detecting means 20, the second voltage difference detecting means 30, the third voltage difference detecting means (not shown), and the defect pixel determining means 40.

Step S24: On the other hand, in the step S24, the line number of the tested pixel of “G” is determined to specify three or five green color pixels which are referred according to the determined line number. That is, as shown in FIG. 3, in the general single-chip imaging sensor S, the number of the pixels of “G” which are sensitively recognized in view of a human visible property is large, and is two times of the sum of the numbers of the pixels of “R” and “B”. The pixels of “G” exist in the diagonal directional sides to surround the tested pixel.

Accordingly, when the line number of the tested pixel is “LNo=1”, that is, the first row, in the location (y, x) of the tested pixel P shown by a bold frame of FIG. 13, three pixels P of (y+1, x−1), (y+1, x+1), and (y+2, x) are specified as the adjacent reference pixel and these reference pixels are set to the first voltage difference detecting means 20, the second voltage difference detecting means 30, the third voltage difference detecting means (not shown), and the defect pixel determining means 40.

Furthermore, when the line number of the tested pixel is “LNo=2”, that is, the second row, in the location (y, x) of the tested pixel P shown by a bold frame of FIG. 13, five pixels P of (y−1, x−1), (y−1, x+1), (y+1, x−1), (y+1, x+1), and (y+2, x) are specified as the adjacent reference pixel and these reference pixels are set to the first voltage difference detecting means 20, the second voltage difference detecting means 30, the third voltage difference detecting means (not shown), and the defect pixel determining means 40.

Furthermore, when the line number of the tested pixel is “LNo=3”, that is, the third row, in the location (y, x) of the tested pixel P shown by a bold frame of FIG. 13, five pixels P of (y−1, x−1), (y−1, x+1), (y−2, x), (y+1, x−1), and (y+1, x+1) are specified as the adjacent reference pixel and these reference pixels are set to the first voltage difference detecting means 20, the second voltage difference detecting means 30, the third voltage difference detecting means (not shown), and the defect pixel determining means 40.

Moreover, when the line number of the tested pixel is “LNo=4”, that is, the fourth row, in the location (y, x) of the tested pixel P shown by a bold frame of FIG. 13, three pixels P of (y−1, x−1), (y−1, x+1), and (y−2, x) are specified as the adjacent reference pixel and these reference pixels are set to the first voltage difference detecting means 20, the second voltage difference detecting means 30, the third voltage difference detecting means (not shown), and the defect pixel determining means 40.

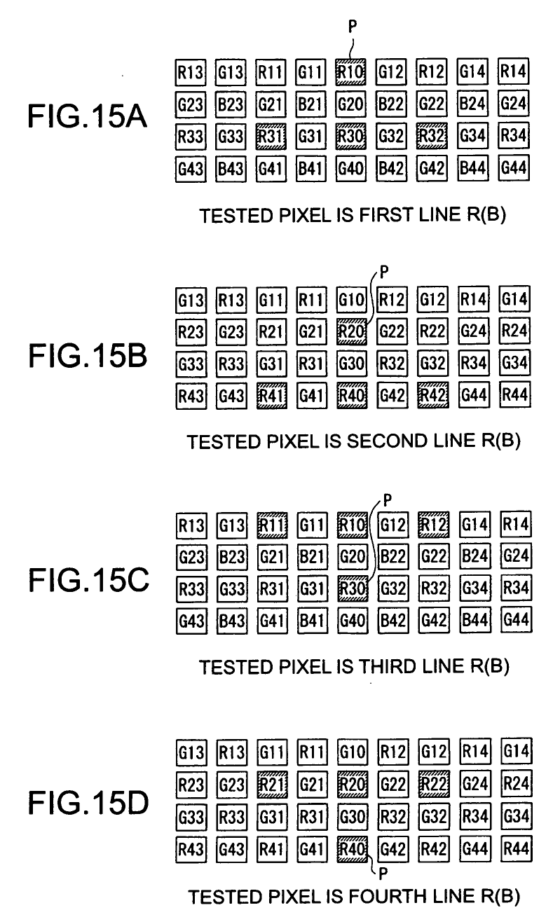

FIGS. 15(A) to (D) illustrate concrete examples of the process of the steps S21 to S23. For example, as shown in FIG. 15A, when the tested pixel P is a red color pixel “R10” of the first row, the reference pixels of the tested pixel P are red color pixels “R31”, “R30”, and “R32” of the third row. As shown in FIG. 15B, when the tested pixel P is a red color pixel “R20” of the second row, the reference pixels of the tested pixel P are red color pixels “R41”, “R40”, and “R42” of the fourth row. As shown in FIG. 15C, when the tested pixel P is a red color pixel “R30” of the third row, the reference pixels of the tested pixel P are red color pixels “R11”, “R10”, and “R12” of the first row. As shown in FIG. 15D, when the tested pixel P is a red color pixel “R40” of the fourth row, the reference pixels of the tested pixel P are red color pixels “R21”, “R20”, and “R22” of the second row.

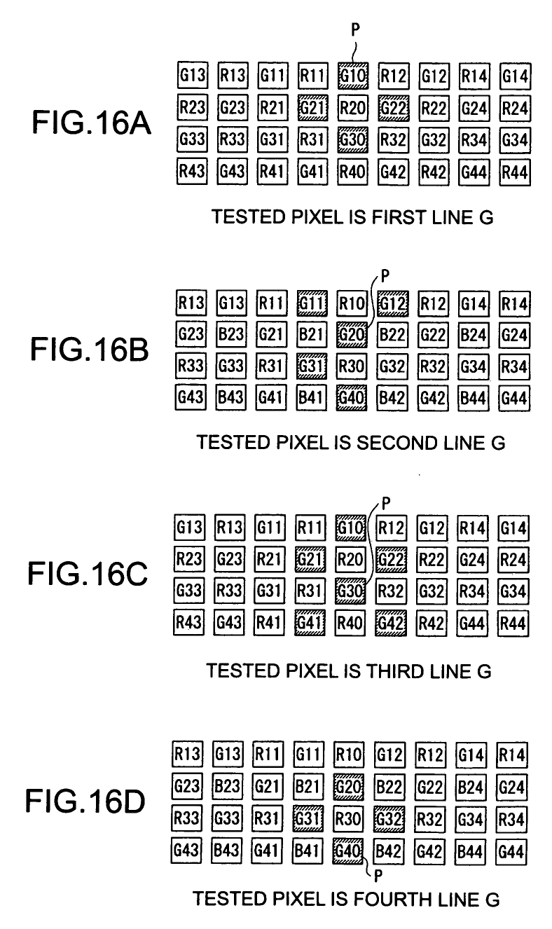

FIGS. 16(A) to (D) illustrate concrete examples of the process of the steps S21 to S24. For example, as shown in FIG. 16A, when the tested pixel P is a green color pixel “G10” of the first row, the reference pixels of the tested pixel P are three green color pixels “G21”, “G30”, and “G22” of the second and third rows. As shown in FIG. 16B, when the tested pixel P is the green color pixel “G20” of the second row, the reference pixels of the tested pixel P are the five green color pixels “G11”, “G12”, “G31”, “G32”, and “G40” of the first, third, and fourth rows. As shown in FIG. 16C, when the tested pixel P is a green color pixel “G30” of the third row, the reference pixels of the tested pixel P are five green color pixels “G10”, “G21”, “G22”, “G41”, “G42” of the first, second, and fourth rows. As shown in FIG. 16D, when the tested pixel P is a green color pixel “R40” of the fourth row, the reference pixels of the tested pixel P are green color pixels “G20”, “G31”, and “G32” of the second and third rows.

Step S25: in a step S25, it is determined whether the tested pixel P is the defect pixel based on the output voltages of the tested pixel P and the reference pixel which are sequentially specified.

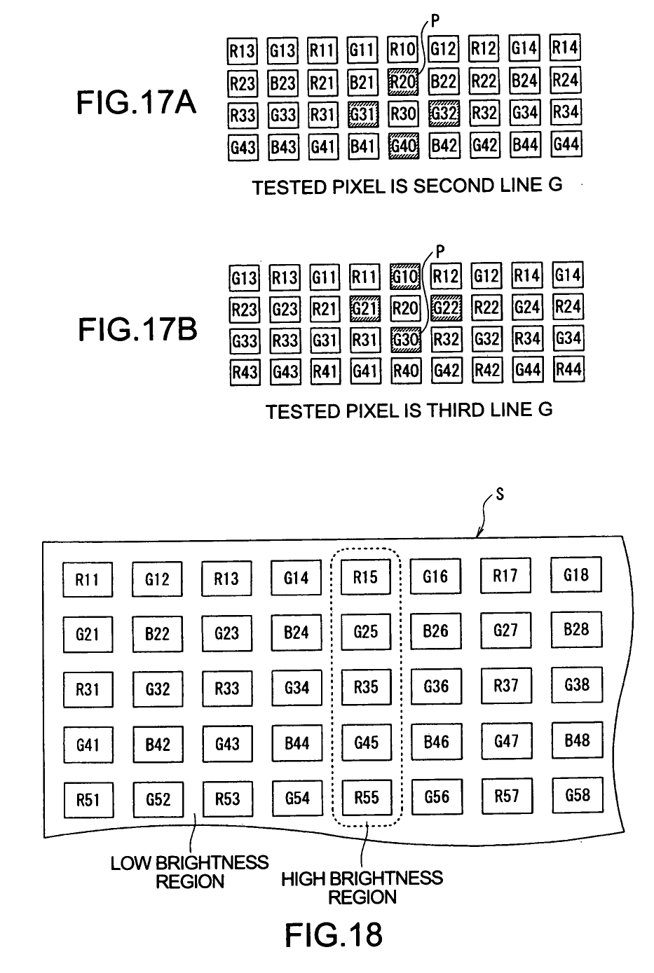

Also, at this time, when the tested pixel P is the green pixel, the tested pixels of first and fourth rows have three reference pixels, but the tested pixels of the second and third rows have five reference pixels. Accordingly, it is accurately determined whether the tested pixel is the defect pixel, but the number of the determining processes increases. Thus, if the green pixels of the second and third rows have three reference pixels similar to the tested pixels of the first and fourth rows as shown in FIGS. 17(A) and (B), it is more rapidly determined whether the tested pixel is the defect pixel.

Step S26: In a step S26, it is determined whether the tested pixel is a last line number, that is, the fourth row (LNo=4). If the tested pixel is not the fourth line (No), the process is progressed to a step S28, and, if the tested pixel is the fourth line (Yes), the process is progressed to a step S27.

Step S28: In the step S28, as shown by an arrow B of FIG. 14, the line of the tested pixel P moves downwardly by one row and then the process is returned to the process S22. All the tested pixels P on the processed line are subjected to the same process.

Step S27: In the step S27, it is determined whether the fourth row which is determined that the process is finished in the step S26 reaches a last line of all the lines of the single-chip imaging sensor S to be tested. If the defect pixel determining process of all the lines is not finished (No), the process is progressed to a step S29.

S29: In the step S29, as shown by an arrow A of FIG. 14, the processed line moves downwardly by one row, the process is returned to the step S20, and the same process is repeated.

Accordingly, if at least four rows of the line memories exist as mentioned above, the four rows of all the pixels can be efficiently tested by one read operation. Also, when, for example, one central line data is generated using the four rows of the pixel data in a post-process, four lines of the line memories is needed. In this case, the line memory is not newly formed to correct the defect pixel, and the defect pixel can be detected using vertical and horizontal correlation.

Moreover, in addition to that it is determined whether the tested pixel “R35” is the defect pixel based on the result of whether the voltage difference “VD(33-35)” is larger than the threshold voltage “Vth1” and whether the voltage difference “VD(34-36)” is smaller than the threshold voltage “Vth2”, based on the voltage differences “VD(13-35)” and “VD(15-35)” between the output voltage “VR35” of the tested pixel “R35” and the output voltages “VR13”, “VR15”, . . . of the next-adjacent pixels “R1338 , “R15”, “R17”, “R33”, “R37”, “R53”, “R55”, and “R57”, for example, as shown in FIG. 18, when the brightness of red light “LR15”, green light “LG25”, red light “LR35”, green light “LG45”, red light “LR55” of the pixels “R15”, “G25”, “R35”, “G45”, and “R55” is larger than that of red light and green light “LR13”, “G14”, “G16”, “R17”, . . . of the other pixels “R13”, “G14”, “G16”, “R17”, . . . , that is, when the pixels “R15” to “R55” are in a high brightness region and the other pixels “R15”, “G25”, . . . are in a low brightness region, it is estimated that the tested pixel “R35” outputs a large voltage by the high brightness. Thus, the tested pixel “R35” is not determined to the defect pixel.

### FOURTH MODIFICATION EXAMPLE

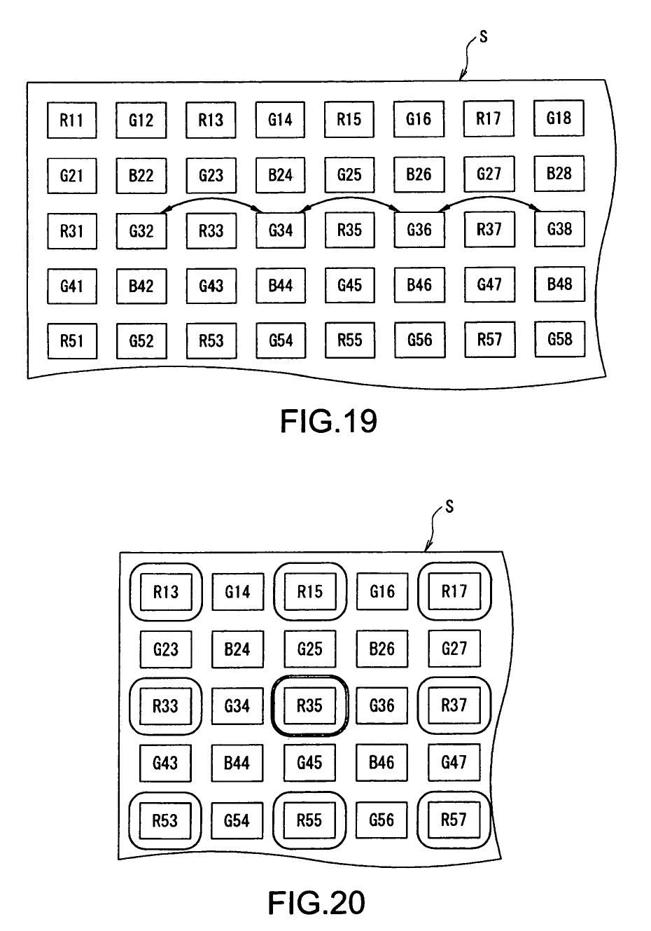

In addition to using the pixels “R33”˜“G36” as mentioned above, as shown in FIG. 19, the voltage difference between the output voltages of two of the pixels “G32”, “G34”, “G36”, and “G38” having the colors different from that of the tested pixel “R35” is sequentially calculated, that is, the voltage difference “VD(32-34)” between the output voltages of the pixels “G32” and “G34”, the voltage difference “VD(34-36)” between the output voltages of the pixels “G34” and “G36” , and the voltage difference “VD(36-38)” between the output voltages of the pixels “G36” and “G38” are sequentially calculated to estimate the brightness distribution of the light L based on the plurality of the calculated voltage differences “VD(32-34)”, etc. More concretely, if all the voltage difference “VD(32-34)”, the voltage difference “VD(34-36)”, the voltage difference “VD(36-38)” are smaller than the predetermined threshold voltage “Vth2”, it is estimated that the brightness distribution of the light “L” is uniform, and, otherwise, the brightness distribution of the light “L” is not uniform. The estimated result is considered when it is determined whether the tested pixel “R35” is the defect pixel and thus the determination precision is improved. Thus, even when the brightness of the red light “LR35” incident to the pixel “R35” is high and the brightness of the green light “LG34” and “LG36” incident to the peripheral pixels “G34” and “G36” is low, the tested pixel “R35” is prevented from being determined to the defect pixel.

### FIFTH MODIFICATION EXAMPLE

Instead of the test of the above-referenced embodiment that it is determined whether the pixel “R35” is the defect pixel based on the voltage difference such as the voltage difference “VD(33-35)”, whether the pixel “R35” is “white defect pixel” or “black defect pixel”, for example, if the brightness of the pixel peripheral to the pixel “R35” is low and the brightness of the pixel “R35” is high by statistical circumferences, when it is determined whether the pixel “R35” is the “white defect pixel”, the voltage difference between the output voltage of the pixel “R35” and the output voltage of the peripheral pixel thereof, for example, the voltage difference “VD(35-33)” between the output voltages of the tested pixel “R35” and the pixel “R33” is larger than the threshold value “Vth1”, it can be determined that the pixel “R35” is the “white defect pixel” and thus the number of the testing processes can be more reduced than that of the above-referenced embodiment.

### SIXTH MODIFICATION EXAMPLE

In the uniform threshold values “Vth1” and “Vth2” of the above-referenced embodiment that the voltage difference such as the voltage difference “VD(33-35)” is compared with uniform (fixed) threshold value “Vth1” or the voltage difference such as “VD(34-36)” is the uniform threshold value “Vth2”, for example, by using the threshold value “VthX (not shown)” which can obtain a different value by a positive correlation in an input/output relationship between the input light “LG35” of the pixel “R35” and the output voltage “VR35”, for example, in a region of which the input light “L” is small (the output voltage “V” is small), the test using a relatively small threshold value “VthX1” is performed, and, in a region of which the input light “L” is large (the output voltage “V” is large), the test using a relatively large threshold value “VthXn (n is any integer) is performed. Thus, even in the region of which the input light “L” is large and the output voltage “V” is large, the probability that the normal pixel is determined to the defect pixel can be reduced.

### Second Embodiment

A pixel correcting method according to a second embodiment will be described.

The pixel correcting method according to the second embodiment corrects the tested pixel which is determined to the defect pixel of which the conversion property is not in the allowable range required for the pixel (the output voltage of the pixel exceeds the allowable range and has high brightness (white)) through the pixel testing method of the first embodiment in the single-chip imaging sensor S shown in FIG. 20 similar to the single-chip imaging sensor S shown in FIG. 1.

In the pixel correcting method of the second embodiment, the output voltage of the pixel which is determined to the defect pixel by the defect determining means 40 of the device 100 is corrected by the output voltage correcting means 50 of the device 100. For example, when the red pixel “R35” is determined to be the defect pixel, as shown in the first embodiment, as shown in FIG. 20, a voltage having highest brightness (most close to white) of the output voltages “VR13”, “VR15”, . . . , “VR57” of “R13”, “R15”, “R17”, “R33”, “R37”, “R53”, “R55”, and “R57” next-adjacent to the pixel “R35” is applied as a voltage “VR35” output from the pixel “R35” which receives red light “LR35”.

More concretely, if the output voltage “VR17” has the highest brightness, the voltage “VR35” output from the pixel “R35” which is the defect pixel is not used, and the output voltage “VR17” is used instead of the voltage “VR35”.

Similarly, if the defect pixel “R35” is original, instead of the voltage “VR35” corresponding to the output brightness, a voltage corresponding to the highest brightness of the output voltages “VR13” to “VR57” of the next-adjacent pixels “R13 to R57”, that is, a voltage (voltage having smallest correction amount) most close to the original output voltage of the defect pixel “R35” is used as the output voltage of the defect pixel “R35” and thus the existence of the defect pixel “R35” can be made not conspicuous.

Similarly, instead of the output voltage of the pixel which is determined to be the defect pixel because the output voltage of the pixel is too small (black) and exceeds the allowable range, by using the voltage having lowest brightness (most close to black) of the plurality of the output voltages next-adjacent to the pixel, the same effect can be obtained.

Instead of the defect pixel of the single-chip imaging sensor S in which the pixels having the same color are next-adjacent to each other, that is, not adjacent to each other, in the defect pixel of the photoelectric transducer in which the pixels having the same color are adjacent to each other, the same output voltage is corrected to obtain the above-referenced effect.

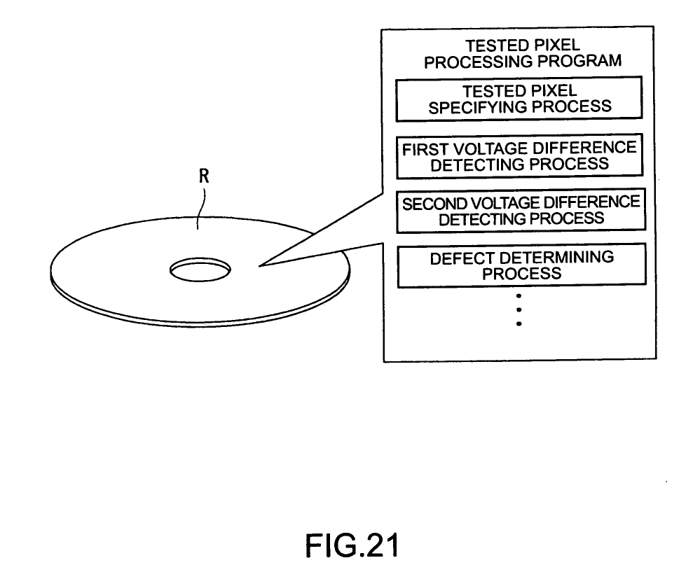

Furthermore, each means or each process for realizing the defect pixel processing device 100 or the defect pixel processing method of the invention can be realized on the software using a computer system for processing an image such as a digital camera, in addition to a general purpose computer such as a PC. The computer program is embedded in a product in the state of being stored in a semiconductor ROM, distributed through a network such as Internet, or stored in a computer-readable recoding medium R such as a CD-ROM or a DVD-ROM, or a FD as shown in FIG. 21 and thus can be easily provided to a user.

What is claimed is:

1. A pixel testing method, wherein, in photoelectric transducers in which a plurality of first color pixels for converting brightness of a first color of at least two colors contained in light from an object to be photographed into a voltage and a plurality of second color pixels for converting brightness of a second color into a voltage, one of the plurality of the first color pixel is a tested pixel, and it is determined whether the tested pixel adjacent to at least two second color pixels of the plurality of the second color pixels is a defect pixel, comprising:
detecting a first voltage difference between two voltages output from the tested pixel and first one of the first color pixels adjacent to first one of the second color pixels which is one of the at least two second color pixels;
detecting a second voltage difference between two voltages output from the first one of the second color pixels and second one of second color pixels which is the other of the at least two second color pixels; and
determining whether the tested pixel is the defect pixel based on the first voltage difference and the second voltage difference.

2. The method according to claim 1, wherein, when a probability that the tested pixel is the defect pixel is estimated based on the first voltage difference, the determination is made whether the estimation is adequate.

3. The method according to claim 1, further comprising detecting a third voltage difference between two voltages output from the tested pixel and third one of the first color pixels adjacent to the second one of the second color pixels,
wherein in the determining, it is determined whether the tested pixel is the defect pixel based on the first voltage difference, the second voltage difference, and the third voltage difference.

4. The method according to claim 3, wherein, when a probability that the tested pixel is the defect pixel is estimated based on the first voltage difference and the third voltage difference, the determination is made whether the estimation is adequate based on the second voltage difference.

5. The method according to claim 1, further comprising estimating light brightness distribution based on a plurality of the third voltage differences obtained by sequentially detecting the third voltage difference between the voltages output from the second color pixels which have a same color and are adjacent to each other with respect to the plurality of the second color pixels,
wherein, in the determining, it is determined whether the tested pixel is the defect pixel with reference to the light brightness distribution estimated by the estimation step.

6. A pixel correcting method which, in a photoelectric transducer having a plurality of pixels for converting brightness of a color contained in light from an object to be photographed into a voltage, corrects an output voltage of a pixel which is determined to be a defect pixel because the voltage exceeds an allowable range related to conversion performance of a plurality of elements and has high brightness, comprising:
applying a voltage corresponding to highest brightness of the voltages output from at least two pixels which sandwiches or surround the pixel as an output voltage of the pixel which is determined to be the defect pixel.

7. A pixel correcting method which, in a photoelectric transducer having a plurality of pixels for converting brightness of a color contained in light from an object to be photographed into a voltage, corrects an output voltage of a pixel which is determined to be a defect pixel because the voltage exceeds an allowable range related to conversion performance of a plurality of elements and has low brightness, comprising:
applying a voltage corresponding to lowest brightness of the voltages output from at least two pixels which sandwiches or surround the pixel as an output voltage of the pixel which is determined to be the defect pixel.

8. A defect pixel processing device of a single-chip imaging sensor having a plurality of pixels including photoelectric transducers which receive light having different colors, comprising:
a tested pixel specifying unit that specifies a predetermined tested pixel of the plurality of the photoelectric transducers;
a first voltage difference detecting unit that detects a voltage difference between an output voltage of the tested pixel specified by the tested pixel specifying unit and an output voltage of an adjacent pixel having the same color as the tested pixel;
a second voltage difference detecting unit that detects a voltage difference between an output voltage of a reference pixel adjacent to the tested pixel and having a color different from that of the tested pixel and an output voltage of another reference pixel having the same color as the reference pixel and adjacent to the reference pixel; and
a defect determining unit that determines defect of the tested pixel based on the voltage difference detected by the first voltage difference detecting unit and the voltage difference detected by the second voltage difference detecting unit.

9. The device according to claim 8, wherein the defect determining unit determines that the tested pixel is not a defect pixel when the voltage difference detected by the first voltage difference detecting unit does not exceed a predetermined threshold value and determines the defect of the tested pixel based on the voltage difference detected by the second voltage difference detecting unit when the voltage difference detected by the first voltage detecting unit exceeds the predetermined threshold value.

10. The device according to claim 8, further comprising a third voltage difference detecting unit which detects a voltage difference between an output voltage of the tested pixel specified by the tested pixel specifying unit and an output voltage of another adjacent pixel having the same color as the tested pixel,
wherein the defect determining unit determines that the tested pixel is not the defect pixel when the voltage difference detected by the third voltage difference detecting unit and the voltage difference detected by the first voltage difference detecting unit does not exceed the predetermined threshold value, and determines that the tested pixel is the defect pixel when one or both of the voltage difference detected by the third voltage difference detecting unit and the voltage difference detected by the first voltage difference detecting unit exceeds the predetermined threshold value.

11. The device according to claim 10, wherein the third voltage difference detecting unit detects the voltage differences between the output voltage of the tested pixel and the output voltages of at least two adjacent pixels having the same color as the tested pixel, respectively, and
the defect determining unit estimates brightness distribution based on a plurality of the voltage differences detected by the third voltage difference detecting unit and determines the defect of the tested pixel based on the brightness distribution.

12. The device according to claim 11, wherein, when the pixels of which the output voltages are detected by the first and second voltage difference detecting units exist in the same line as the tested pixel, the third voltage difference detecting unit selects another adjacent pixel having the same color on a line separate from the corresponding line and detects the voltage difference between the output voltage of the adjacent pixel and the output voltage of the tested pixel.

13. The device according to claim 12, comprising a storing unit which stores the output voltage of each pixel in an N-line unit of all the pixels of a single-chip imaging sensor,
wherein the third voltage difference detecting unit selects another adjacent pixel having the same color on a line separate from the corresponding line and detects the voltage difference between the output voltage of the adjacent pixel and the output voltage of the tested pixel, in a range of each pixel stored in the storing unit.

14. The device according to claim 10, wherein the third voltage difference detecting unit detects the voltage differences between the output voltage of the tested pixel and the output voltages of at least two adjacent pixels having the same color as the tested pixel, respectively,
wherein the defect determining unit estimates brightness distribution based on the plurality of the voltage differences detected by the third voltage difference detecting unit and determines the defect of the tested pixel based on the brightness distribution.

15. The device according to claim 8, comprising an output voltage correcting unit that corrects the output voltage of the tested pixel which is determined to be the defect pixel by the defect determining unit,
wherein the output voltage correcting unit corrects the output voltage of the defect pixel to the output voltage corresponding to highest brightness of the voltages output from at least two adjacent pixels which sandwich or surround the defect pixel.

16. The device according to claim 8, comprising an output voltage correcting unit that corrects the output voltage of the tested pixel which is determined to be the defect pixel by the defect determining unit,
wherein the output voltage correcting unit corrects the output voltage of the defect pixel to the output voltage corresponding to lowest brightness of the voltages output from at least two adjacent pixels which sandwich or surround the defect pixel.

17. A defect pixel processing program which detects a defect pixel of a single-chip imaging sensor having a plurality of pixels including photoelectric transducers which receives light having different colors, and allows a computer to function as
a tested pixel specifying unit that specifies a predetermined tested pixel of the plurality of the photoelectric transducers;
a first voltage difference detecting unit that detects a voltage difference between an output voltage of the tested pixel specified by the tested pixel specifying unit and an output voltage of an adjacent pixel having the same color as the tested pixel;
a second voltage difference detecting unit that detects a voltage difference between an output voltage of a reference pixel adjacent to the tested pixel and having a color different from that of the tested pixel and an output voltage of another reference pixel having the same color as the reference pixel and adjacent to the reference pixel; and
a defect determining unit that determines defect of the tested pixel based on the voltage difference detected by the first voltage difference detecting unit and the voltage difference detected by the second voltage difference detecting unit.

18. A computer-readable recoding medium having embodied thereon the defect pixel processing program of claim 17.

19. A method of detecting a defect pixel of a single-chip imaging sensor having a plurality of pixels including photoelectric transducers which receive light having different colors, comprising:
specifying a predetermined tested pixel of the plurality of the photoelectric transducers;
detecting a voltage difference between an output voltage of the tested pixel specified by the tested pixel specifying unit and an output voltage of an adjacent pixel having the same color as the tested pixel;
detecting a voltage difference between an output voltage of a reference pixel adjacent to the tested pixel having a color different from that of the tested pixel and an output voltage of another reference pixel having the same color as the reference pixel and adjacent to the reference pixel; and
determining the defect of the tested pixel based on the voltage difference detected by the first voltage difference detecting unit and the voltage difference detected by the second voltage difference detecting unit.
